(19) United States
(12) Patent Application Publication
(10) Pub. No.: US 2017/0030288 A1
(43) Pub. Date: Feb. 2, 2017

(54) Method for Operating a High Pressure Pump of an Injection System and an Injection System

(71) Applicant: CONTINENTAL AUTOMOTIVE GMBH, Hannover (DE)

(72) Inventor: Michael Wirkowski, Regensburg (DE)

(73) Assignee: CONTINENTAL AUTOMOTIVE GMBH, Vahrenwalder Straße 9 (DE)

(21) Appl. No.: 15/301,483

(22) PCT Filed: Mar. 5, 2015
(86) PCT No.: PCT/EP2015/054602

§ 371 Date: Oct. 3, 2016

(30) Foreign Application Priority Data
Apr. 2, 2014 (DE) 10 2014 206 231.4

(51) Int. Cl. F02D 41/38; F02D 33/00

(52) U.S. Cl. CPC F02D 41/38; F02D 33/00; F02D 2200/06; F02D 2041/2051

(57) ABSTRACT

A method for operating a high-pressure pump of an injection system and an injection system is provided. The method relates to a switching off of additional pulses, which are applied to a valve of the high-pressure pump, if the determined coil temperature of the valve exceeds a limit value. The method is, for instance, then carried out if additional pulses are applied to the valve to reduce noise (“whisper function”). Current information and voltage information from the control signal of the valve of the high-pressure pump are used to measure the temperature of the valve and switch off additional current pulses through this information if there is a risk of the valve overheating. The disclosure further describes an injection system of a combustion engine, wherein the injection system comprises a high-pressure pump having a valve and a corresponding control unit.

### TECHNICAL FIELD

The disclosure relates to a method for operating a high pressure pump of an injection system of a combustion engine in which a valve in the high pressure pump is opened and/or closed by way of a control unit by means of influencing the coil of the valve by way of a control pulse.

### BACKGROUND

In the case of injection systems in internal combustion engines, the required fuel pressure is generated by means of mechanically driven high-pressure pumps. High-pressure pumps of this type are embodied by way of example as radial piston pumps and include a pump housing in which a pump piston is movably mounted. A pressure chamber is located at one end of the pump piston in the pump housing. In order to be able to fill the pressure chamber with fluid, the pressure chamber includes a supply line in which a valve that is embodied as an inlet valve is arranged. This valve is preferably embodied as a digitally controlled valve. Moreover, the pressure chamber includes a discharge line in which a further valve that is embodied as an outlet valve is arranged. Fluid can consequently be discharged from the pressure chamber.

Valves of this type are subjected to heavy loadings, in particular if they are exposed to permanent loadings, such as for example in high pressure pumps. Since high-pressure pumps are subjected to pressures of by way of example 2,000 bar or more, high requirements are placed on the valves in pumps of this type. Noises can occur both as these valves close and also as they open.

It is known in the case of valves of this type to provide in addition to an opening pulse and/or a closing pulse an additional braking pulse so as to reduce the noise development. By virtue of the additional influence by way of a braking pulse of this type or “whispering pulse”, it is possible to close the valve slowly or open the valve slowly in such a manner that the magnitude of noise developed by the valve can be kept small whilst still being able to achieve a reliable and sufficiently rapid closing or opening of the valve. Furthermore, the wear on the valve may be kept to a minimum. Details of a braking pulse or “whispering pulse” are described by way of example in DE 10 2011 075 269 A1.

The amount of electrical power that is consumed by the high-pressure pump is dependent upon the control of the high-pressure pump. The amount of electrical power consumed is thus increased by virtue of above mentioned, additional braking pulse or “whispering pulse”. However, if external influences are already creating a high thermal loading on the pump, by way of example by means of engine waste heat and/or a high external temperature, it can be necessary to reduce the amount of electrical energy being supplied so that the corresponding valve does not “burn out”. This may cause the insulating material of the associated coil to fail as a result of excessively high temperatures and a short circuit can occur between the windings. The resulting reduced coil resistance leads to a higher electrical short that in turn leads to a higher temperature. A causal circuit is therefore produced that causes the valve to fail within a very short period of time. There is also the risk of fire as a result.

In order to solve this problem, the electrical loading on the high pressure pump has been reduced. In so doing, additional functions of the high pressure pump, such as by way of example the above mentioned braking pulse or “whispering pulse” are blindly switched off once a specific rotational speed has been achieved and in fact regardless of whether the switch off is necessary. Disadvantages of this mode of functioning of the high pressure pump, in particular a corresponding development of noise in the valves, have been accepted. However, since the noise that is caused in the high-pressure pump by the additional “whispering pulse” is reduced by means of minimizing the forces on the moving parts of the pump, the durability of the high-pressure pump, in particular of the valves themselves, is also reduced as a result of switching off the “whispering pulse” early. As a result of the known method of switching off the “whispering pulse” without it actually being necessary, the serviceable life of the high pressure pump is consequently reduced.

### SUMMARY

Therefore, it is desirable to provide a method of the type mentioned in the introduction, where it is possible to counteract in a particularly simple and effective manner any risk of the high pressure pump in an injection system overheating. One aspect of the disclosure provides the method that includes: measuring an electrical current that a valve uses to open and/or to close; measuring the electrical voltage that is prevailing at the valve; calculating the electrical resistance of the coil; determining the coil temperature from the calculated coil resistance; and switching off additional pulses with which the valve is influenced if the determined coil temperature exceeds a limit value.

Implementations of the disclosure may include one or more of the following optional features. In accordance with the disclosure, additional pulses, in particular a “whispering pulse,” are not blindly switched off, but rather the additional pulses are switched off in a purposeful manner if the determined coil temperature exceeds a limit value. If a temperature is determined at which damage could occur to the coil, the additional pulses are switched off. However, this consequently only occurs when there is an actual risk of damage and not just as a precaution. As a result of switching off the additional pulses, the electrical loading on the pump is less and the coil temperature reduces.

In order to determine the coil temperature, the electrical current that is used by the valve to open and/or to close, and also the electrical voltage that is prevailing at the valve are measured, and the electrical resistance of the coil is calculated from the value that is determined. This value is dependent upon the coil resistance at nominal temperature (20° C.) and the coil temperature. In the case of a specific coil, the coil temperature is consequently allocated unambiguously to a temperature that may be determined by means of simple calculating operations. If the determined coil temperature exceeds a limit value, additional pulses are switched off so that overloading is prevented in a simple and effective manner.

As mentioned in the introduction, additional pulses are applied in particular in order to minimize noise development in the high-pressure pump or the corresponding valves. In accordance with the disclosure, additional pulses with which the valve is influenced so as to reduce noise development are therefore switched off. The relevant “whispering pulse” is therefore switched off if a temperature is determined at which damage can occur to the coil. Damage to the coil as a result of excess temperature is therefore avoided in accordance with the disclosure in particular in the case of a “whispering pulse”. This also results in the operating range of the “whispering pulse” being extended (in comparison to blindly switching off the pulse). Overall, the pump is therefore quiet in an extended operating range and its life expectancy increases.

In some examples, the current that the valve uses to open and/or to close is measured by a shunt resistor in the control unit. Since a shunt resistor of this type is already part of the control unit owing to the above described whispering function, the protection against overloading provided in accordance with the disclosure in the case of this example is not associated with additional costs.

It is possible with the knowledge of the coil resistance to measure in an expedient manner a resistance at normal temperature and for the calculation of the prevailing coil temperature to be stored. It is thus possible to be able to measure by way of example the resistance at 20° C. (R20). In some examples, this can be achieved if the associated motor has been idle longer than 12 hours. This can be determined by means of the “engine off timer” and/or by means of the identical temperature measured value of the cooling water temperature (TCO) and the ambient temperature (TAM).

The resistance may however also be measured at a different temperature than 20° C. The calculation is then related to the R20 value in a simple manner. In particular, an inlet valve is controlled in an identical manner to the valve in the high pressure pump.

In some implementations, the current and voltage information is consequently used by the activation signal of a valve in the high pressure pump in order to measure its temperature (the coil temperature) and on the basis of this information then to switch off additional current pulses, in particular the “whispering pulse” if there is a risk of the valve overheating.

Moreover, the present disclosure relates to an injection system of an internal combustion engine including a high-pressure pump having a valve and a control unit for opening and/or closing the valve by means of influencing a coil of the valve by way of a current pulse.

Another aspect of the disclosure provides an injection system. The injection system includes: a device for measuring the electrical current that the valve uses to open and/or to close; a device for measuring the electrical voltage that is prevailing at the valve; a device for calculating the electrical resistance of the coil; a device for determining the coil temperature from the calculated coil resistance; a device for influencing the valve by way of additional pulses and a device for switching off the device for influencing the valve by way of additional pulses if the determined coil temperature exceeds a limit value.

The devices that are provided in accordance with this aspect of the disclosure may be integrated into the control unit of the combustion engine.

In some examples, the device for influencing the valve by way of additional pulses is a device for influencing the valve by way of pulses that reduce the noise development (“whispering pulse”).

The device for measuring the electrical current that the valve uses to open and/or to close may be a shunt resistor in the control unit. Such a shunt resistor is already available if a device for generating a “whispering pulse” is provided.

The injection system can moreover include a device for measuring the coil resistance at normal temperature.

The valve in the high-pressure pump may be an inlet valve.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 illustrates a schematic longitudinal section view of an exemplary high-pressure pump having a valve.

FIG. 2 illustrates a flow diagram of the method in accordance with the exemplary high-pressure pump.

Like reference symbols in the various drawings indicate like elements.

### DETAILED DESCRIPTION

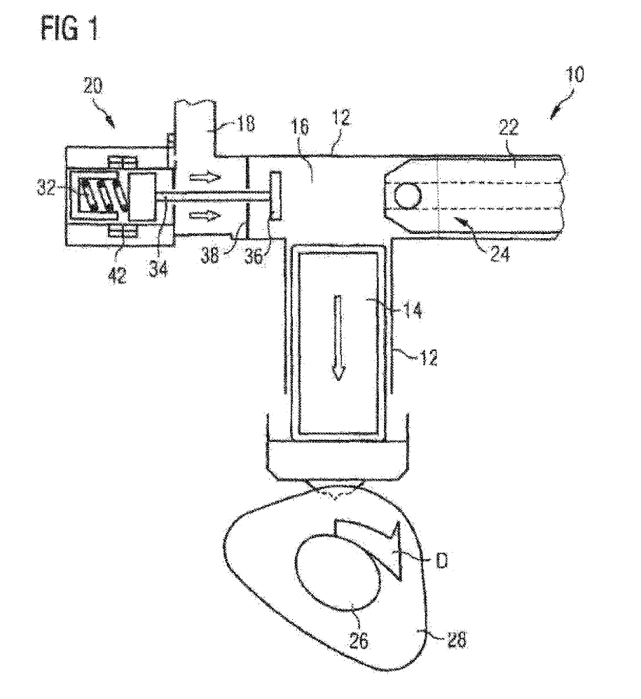

FIG. 1 illustrates a schematic view of a high-pressure pump 10 of an injection system of a combustion engine. The pump 10 includes a pump housing 12 and is embodied in the case of the example as a radial piston pump. A pump piston 14 is movably mounted in the pump housing 12. A pressure chamber 16 is located in the pump housing 12 at one end of the pump piston 14. To be able to fill the pressure chamber 16 with fluid, the pressure chamber includes a supply line 18 in which is arranged a valve 20 that is shown as an inlet valve. The valve 20 that is shown as an inlet valve may be a digitally controlled valve. The valve 20 facilitates the procedure of filling the pressure chamber 16 and prevents the fluid flowing back out of the supply line 18 during the filling procedure. The pressure chamber 16 includes moreover a discharge line 22 in which a further valve 24 that is embodied as an outlet valve is arranged. As a result, fluid can be discharged from the pressure chamber 16.

Furthermore, and in some examples, the pump 10 includes a drive shaft 26 that is operatively connected to an eccentric cam 28 and can rotate in a direction of rotation D in the clockwise direction.

In some implementations, the valve includes a valve housing having a cavity in which a spring 32, a rod 34, and a sealing element 36 are arranged. The spring 32 pretensions the sealing element 36 by way of the rod 34, in that the spring is supported on a wall of the cavity. Furthermore, a seal seat 38 that is fixedly arranged opposite the valve housing 29 may be located in the cavity and the seal seat includes through-going cut-outs. Fluid may flow by way of the through-going cut-outs if the sealing element 36 is not lying against the seal seat 38. In some examples, the valve 20 includes an actuator 42. The actuator 42 may be a magnetic coil. The rod 34 may be arranged in part within the actuator 42 and may be actuated by the actuator 42. The precise construction of a valve of this type is described in the document DE 10 2011 075 269 A1 already mentioned in the introduction. The valve is designed and functions in such a manner that the noise development during opening the valve is reduced by means of applying additional current pulses. This so-called “whispering function” is described in detail in the above mentioned publication.

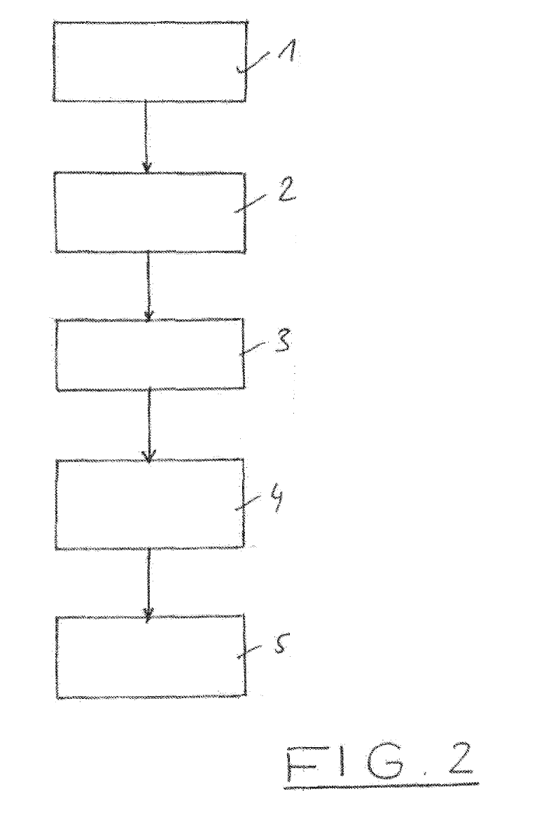

In the case of the method in accordance with the disclosure, these additional pulses with which the valve is influenced so as to reduce noise development are now switched off (“whispering function”) if the determined coil temperature of the valve exceeds a limit value. In so doing, the “whispering pulse” is not blindly switched off once a specific rotational speed has been achieved but rather, as illustrated in FIG. 2, the electrical current that is used by the valve to open is measured in Step 1. In Step 2, the electrical voltage that is prevailing at the valve is measured. The resistance of the valve coil is calculated from the two values according to the formula R=U/I (Step 3). This value is dependent upon the coil resistance at nominal temperature (20° C.) and the coil temperature. The coil temperature is thus unambiguously allocated to a temperature in the case of a specific coil. The coil temperature may then be calculated as follows (Step 4):

Rt=R20*(1+a20*(t−20° C.))→t=20° C.+(Rt/R20−1)/a20.

If in so doing a temperature is determined at which damage may occur to the coil, the “whispering pulse” is switched off (Step 5). However, this consequently only occurs when there is an actual risk of damage and not just as a precaution. As a result of switching off the pulse, the electrical loading on the pump is less.

The parameters included in the above equation have the following meaning:
Rt=Resistance at temperature t
R20=Resistance at 20° C.
t=Temperature being determined
a20=Temperature coefficient

A number of implementations have been described. Nevertheless, it will be understood that various modifications may be made without departing from the spirit and scope of the disclosure. Accordingly, other implementations are within the scope of the following claims.

What is claimed is:

1. A method for operating a high pressure pump of an injection system of an internal combustion engine in which a valve in the high pressure pump is opened and/or closed by way of a control unit by means of influencing the coil of the valve by way of a control pulse of the type mentioned, the method comprising the following steps:
measuring an electrical current that the valve uses to open and/or to close;
measuring an electrical voltage that is prevailing at the valve;
calculating an electrical resistance of the coil;
determining a coil temperature from the calculated coil resistance; and
switching off additional pulses with which the valve is influenced if the determined coil temperature exceeds a limit value.

2. The method of claim 1, where additional pulses with which the valve is influenced so as to reduce noise development are switched off.

3. The method of claim 1, wherein the current that the valve uses to open and/or to close is measured by a shunt resistor in the control unit.

4. The method of claim 1, wherein with the knowledge of the coil resistance a resistance is measured at normal temperature and stored for the calculation of the prevailing coil temperature value.

5. The method of claim 1, wherein an inlet valve is controlled in an identical manner to the valve in the high pressure pump.

6. An injection system of an internal combustion engine comprising:
a high pressure pump having a valve and a control unit for opening and/or closing the valve by means of influencing a coil of the valve by way of a current pulse;:
a device for measuring the electrical current that the valve uses to open and/or to close;
a device for measuring the electrical voltage that is prevailing at the valve;
a device for calculating the electrical resistance of the coil;
a device for determining the coil temperature from the calculated coil resistance;
a device for influencing the valve by way of additional pulses; and
a device for switching off the device for influencing the valve by way of additional pulses if the determined coil temperature exceeds a limit value.

7. The injection system of claim 6, wherein the device for influencing the valve by way of additional pulses is a device for influencing the valve by way of pulses so as to reduce the noise development.

8. The injection system of claim 6, wherein the device for measuring the electrical current that the valve uses to open and/or to close is a shunt resistor in the control unit.

9. The injection system of claim 6, further comprising a device for measuring the coil resistance at normal temperature.

10. The injection system of claim 6, wherein the valve in the high pressure pump is an inlet valve in the high pressure pump.
